(19) United States
(12) Patent Application Publication
(10) Pub. No.: US 2005/0279686 A1
(43) Pub. Date: Dec. 22, 2005

(54) Multifunctional oxygenaged water generation system

(76) Inventor: Maxwell Hsu, Tao-Yuan (TW)

Correspondence Address: Yi-Wen Tseng, 4331 Stevens Battle Lane, Fairfax, VA, 22033, US

(21) Appl. No.: 10/871,562

(22) Filed: Jun. 21, 2004

(51) Int. Cl. C02F 1/78

(52) U.S. Cl. 210/192

(57) ABSTRACT

A multifunctional oxygenated water generation system includes a water generator and a control device. The water generator includes a first filter, a second filter, a water tank, an ozone generator, a gas-water mixer, a deoxygenator and a plurality of switches. The control device includes a microprocessor and a driving unit controlled by the microprocessor, for controlling the water generator to produce high concentration electrolised ozonated water, super oxygenated electrolised ozonated water or super oxygenated electrolised ion water. The microprocessor has a timer for counting and make the driving unit control the ozone generator to generate ozone gas and send to the gas-water mixer at a predetermined time when the water generator is shut off so that while the water generator is turned on again, the high concentration electrolised ozonated water, the super oxygenated electrolised ozonated water or the super oxygenated electrolised ion water can be promptly provided.

### BACKGROUND OF THE INVENTION

The present invention relates in general to a multifunctional oxygenated water generation system, and more particularly, to a multifunctional oxygenated water generation system having a control device to make ozone gas continue to be generated at a predetermined time when a water generator of the system is shut off so that while the water generator is tuned on again, it can promptly provide the consumers the high concentration electrolised ozonated water, or potable super oxygenated electrolised ozonated water or super oxygenated electrolised ion water.

Most drinking water machine utilize several pre-filters to remove the solid sediments from the water, then use a reverse osmosis filter to further remove other impurities, and finally use a post-filter to remove any strange odor from the water. Water that has gone through this process becomes safe and potable and is referred to as pure water. However, there is a problem that arises from this kind of filtering. This problem arises because the filtering process skims out both dirty particles and organic materials. The skimmed out organic material gradually accumulates with usage and facilitates the growth of unwanted bacteria in the filters. In order to avoid the health effects of the unwanted bacteria the consumer is forced to change the filters frequently. If the consumer does not change the filters frequently the bacteria density in the water produced will exceed the standard allowed for potable water.

Furthermore, even though the container is a closed space it is still highly probable that the container will become a virtual nirvana for bacteria. The water delivery outlet closest to the container is the most vulnerable to contamination by bacteria, but this is by no means the only site of potential contamination. This is because once the water delivery outlet closest to the container is contaminated, the bacteria will likely migrate to the rear of the container. There is, therefore, a need to kill the bacteria in the container.

In order to kill the bacteria in the container an ozone generator is installed in an ozonated water producer. The Ozone produced from this ozone generator will dissolve into the water producing ozonated water. This ozonated water will then effectively suppress the growth of the unwanted bacteria. However, the conventional ozonated water producer requires a longer period of time in order for it to dissolve the ozone into its pure water. Because of the longer period of time required by the conventional ozonated water producer, it could not produce ozonated water quickly enough for the consumer; the time required by the conventional ozonated water producer made its use inconvenient to consumers.

### BRIEF SUMMARY OF THE INVENTION

The present invention provides a multifunctional oxygenated water generation system with a control device to make ozone gas continue to be generated at a predetermined time when a water generator of the system is shut off so that while the water generator is tuned on again, it can promptly provide high concentration electrolised ozonated water, or potable super oxygenated electrolised ozonated water or super oxygenated electrolised ion water.

The multifunctional oxygenated water generation system provided by the present invention including a water generator and a control device. The water generator includes a first filter, a second filter, a water tank, an ozone generator, a gas-water mixer, a deoxygenator and a plurality of switches. The control device includes a microprocessor and a driving unit controlled by the microprocessor, for controlling the water generator to produce high concentration electrolised ozonated water, super oxygenated electrolised ozonated water or super oxygenated electrolised ion water. The microprocessor has a timer for counting and make the driving unit control the ozone generator to generate ozone gas and send to the gas-water mixer at a predetermined time when the water generator is shut off so that while the water generator is turned on again, the high concentration electrolised ozonated water, the super oxygenated electrolised ozonated water or the super oxygenated electrolised ion water can be promptly provided.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a system diagram of a water generator of the multifunctional oxygenated water generation system.

FIG. 2 is a block diagram of a control device of the multifunctional oxygenated water generation system.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

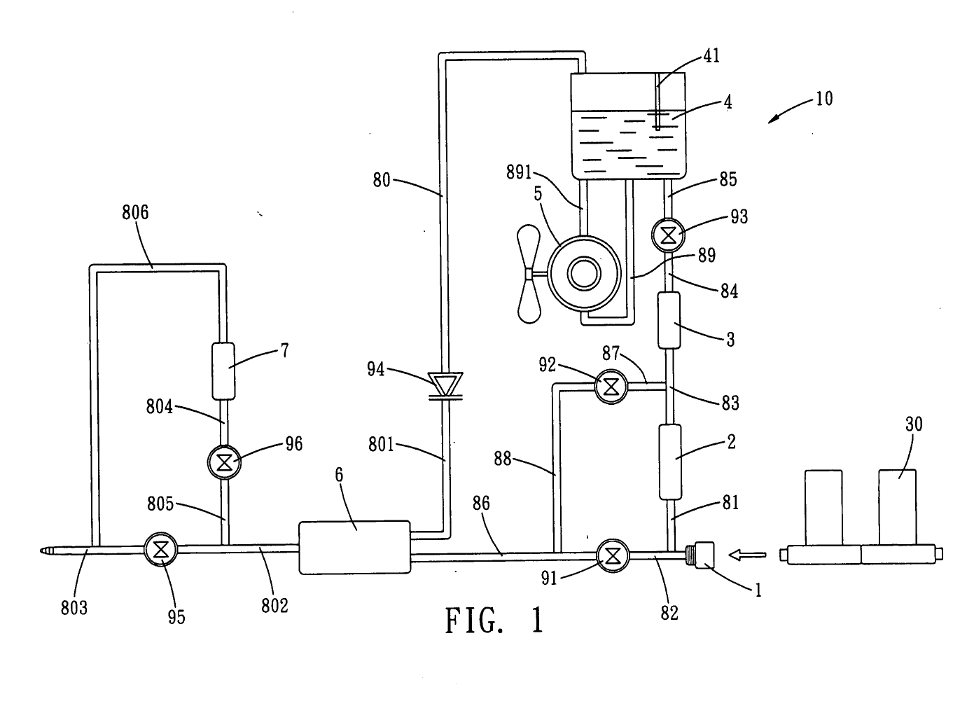

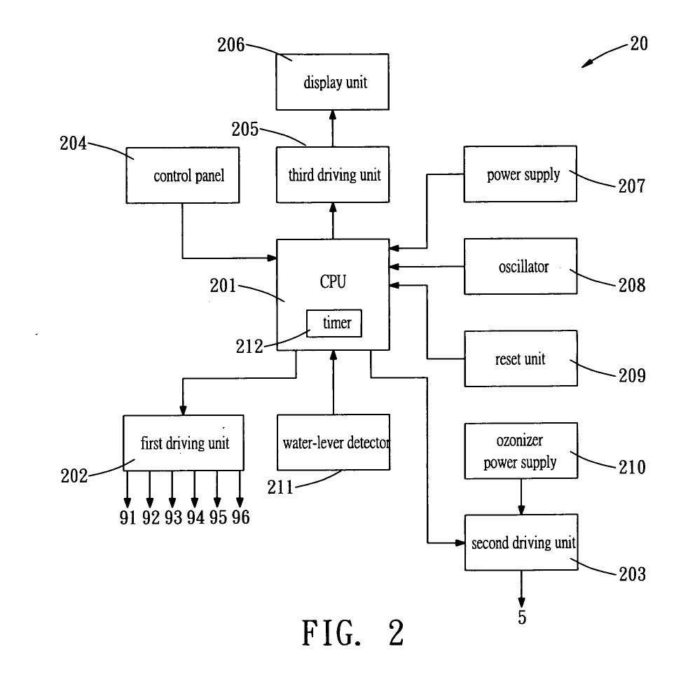

Referring to FIGS. 1 and 2, a multifunctional oxygenated water generation system of the present invention includes a water generator 10 and a control device 20. The water generator 10 includes a water inlet 1, a first filter 2 connected to the water inlet 1, a second filter 3 connected to the first filter 2, a water tank 4 connected to the second filter 3, an ozone generator 5 for producing ozone gas to the water tank 4, a gas-water mixer 6 for mixing water with the ozone gas to produce high concentration electrolised ozonated water or potable super oxygenated electrolised ozonated water, a deoxygenator 7 for further processing the super oxygenated electrolised ozonated water to produce potable super oxygenated electrolised ion water, and a plurality of pipelines 8 and control switches 9 respectively connected therebetween. The control device 20 includes a microprocessor 201 with a timer 212 inside, a first driving unit 202, a second driving unit 203, a control panel 204, a third driving unit 205, a display unit 206, a power supply 207, an oscillator 208, a reset unit 209, an ozonizer power supply 210 and a water-level detector 211.

Before entering the water generator 10, the source water can be filtered by an external filter 30. The external filter 30 connects to the external hoses through a water inlet in order to receive the source water generated from the public water system. The external filter 30 can output preliminary clean water from the water inlet 1 through a pipeline 81 or 82. A first switch 91 is connected to the pipeline 82 and a pipeline 86 is further connected to the first switch 91.

The first filter 2 includes a filter cartridge containing copper ions, zinc ions, and activated carbon ions. The first filter 2 can further eliminate the residual chlorine, heavy metal elements, and bacteria from the entering preliminary clean water which arrived from the external filter 10. The pipeline 81 is connected between the first filter 2 and the water inlet 1. The first filter 2 further connects an output pipeline 83. Moreover, two pipelines 87 and 88 with a second switch 92 connected therebetween are respectively connected to the pipelines 83 and 86.

The second filter 3 connects to the first filter 2 via the pipeline 83. The second filter 3 can eliminate the anions and cations of the clean water in order to obtain a high purity deionized water called pure water. The second filter 3 further connects an output pipeline 84 to a third switch 93.

The water tank 4 stores the pure water generated by the second filter 3 and the ozone gas generated by the ozone generator 5. The water tank 4 connects to the second filter 3 via a pipeline 85 to the third switch 93 which controls the conveying of the pure water generated by the second filter 3. The water tank 4 further connects an output pipeline 80 to a fourth switch 94 with a pipeline 801 connected thereto.

The ozone generator 5 has an electrolytic cell which can splits water into its basic elements and then convert part of the liberated oxygen into ozone. The ozone generator 5 receives the pure water via a pipeline 89. The ozone generator 5 outputs the mixture of ozone, oxygen and water to the water tank 4 via a pipeline 891. The ozone gas stored in the water tank 4 can flow to the gas-water mixer 6 via the pipeline 80.

The gas-water mixer 6 is a pressurized gas-water mixer. Both the pipelines 86 and 801 are connects to the gas-water mixer 6 which further connects an output pipeline 802 to a water delivery switch, i.e. a fifth switch 95 with a pipeline 803 connected thereto.

The deoxygenator 7 includes an activated carbon particle or powder filter cartridge containing sliver. Two pipelines 804 and 850 with a sixth switch 96 therebetween are respectively connected to the deoxygenator 7 and the pipeline 802. The deoxygenator 7 further connects a pipeline 806 to the pipeline 803.

Under the control of the control device 20, the water generator 10 can produce potable super oxygenated electrolised ozonated water as follows. Firstly, the microprocessor 201 controls the first driving unit 202, such as a relay, to close the first switch 91, such as a solenoid valve, and the second switch 92. The source water to be filtered by the external filter 30 is inputted from the water inlet 1 to flow through the pipeline 81 to the first filter 2, and then through the pipeline 83 to the second filter 3. The pure water outputted from the second filter 3 is then sent to the water tank 4 for storage. Secondly, the microprocessor 201 controls the first driving unit 202 to close the first switch 91 and the sixth switch 96, and to open the second switch 92 and the fifth switch 95. The microprocessor 201 further controls the second driving unit 203 to have the ozone generator 5 receive the pure water via the pipeline 89 to produce a mixture of ozone, oxygen and water and output the mixture to the water tank 4 via the pipeline 891. The ozone gas can further flow to the gas-water mixer 6 via the gas pipeline 80 under the control of the fourth switch 94, such as a check valve. Meanwhile, the clean water outputted from the first filter 1 is directed to the gas-water mixer 6 via the pipeline 87, the second switch 92, and the pipelines 88 and 86. The gas-water mixer 6 mixes the clean water and the ozone gas, and thereby the water generator 10 outputs the super oxygenated electrolised ozonated water from the pipeline 803 via the fifth switch 95.

While producing the super oxygenated electrolised ion water, the microprocess 201 controls the first driving unit 202 to close the fifth switch 95 and to open the sixth switch 96. Therefore, the super oxygenated electrolised ozonated water is directed to the deoxygenator 7 for further deoxygenation process, and then the super oxygenated electrolised ion water is produced from the pipeline 803 through the pipeline 806.

Furthermore, under the control of the control device 20, the water generator 10 can produce high concentration electrolised oznated water as follows. The microprocessor 201 controls the first driving unit 202 to close the second switch 92 and the sixth switch 96 and to open the first switch 91 and the fifth switch 95. Similarly, the ozone gas will flow to the gas-water mixer 6 via the gas pipeline 80 under the control of the fourth switch 94, but it is the water directly from the water inlet 30 to be directed to the gas-water mixer 6 via the pipeline 82, the first switch 91, and the pipeline 86. The gas-water mixer 6 mixes the input water and the ozone gas, and thereby outputs the high concentration electrolised ozonated water from the pipeline 803 via the pipeline 802 and the fifth switch 95.

Moreover, when the water generator is shut off by pushing a power-off key on the control panel 204, the timer 212 of the control device 20 begins to count. Meanwhile, the microprocessor 201 respectively controls the first and the second driving unit 202, 203 to close the first, the second and the fifth switches 1, 2 and 5 but to keep the ozone generator 5 on and the ozone gas still to send to the gas-water mixer 6 for storage. In case, if too much ozone gas is sent to the gas-water mixer 6, the excess ozone gas will release from the gas-water mixer 6 via the pipelines 802, 805, the sixth switch 96 and the pipeline 804 to the deoxygenator 7 for reduction to oxygen. Therefore, no more ozone will be discharged to the environment.

After four minutes counting of the timer 212, the microprocessor 201 further controls the first and the second driving unit 202, 203 to close the sixth switch 96 and to stop the operation of the ozone generator 5, respectively. Therefore, while the water generator 10 is tuned on again, either the high concentration electrolised ozonated water, or potable super oxygenated electrolised ozonated water or super oxygenated electrolised ion water can be promptly provided.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A multifunctional oxygenated water generation system comprising:
a water generator including a first filter, a second filter, a water tank, an ozone generator, a gas-water mixer, a deoxygenator and a plurality of switches; and
a control device including a microprocessor and a driving unit controlled by the microprocessor, for controlling the water generator to produce high concentration electrolised ozonated water, super oxygenated electrolised ozonated water or super oxygenated electrolised ion water,
wherein the microprocessor has a timer for counting and make the driving unit control the ozone generator to generate ozone gas and send to the gas-water mixer at a predetermined time when the water generator is shut off so that while the water generator is turned on again, the high concentration electrolised ozonated water, the super oxygenated electrolised ozonated water or the super oxygenated electrolised ion water can be promptly provided.

2. The multifunctional oxygenated water generation system of claim 1, wherein the gas-water mixer discharges an excess ozone gas through the deoxygenator to reduce the ozone gas to oxygen.

3. The multifunctional oxygenated water generation system of claim 1, wherein the driving unit is a relay.

4. The multifunctional oxygenated water generation system of claim 1, wherein the switch is a solenoid valve.

5. The multifunctional oxygenated water generation system of claim 1, wherein the switch is a check valve.
